(19) United States
(12) Patent Application Publication
(10) Pub. No.: US 2007/0188973 A1
(43) Pub. Date: Aug. 16, 2007

(54) ACTIVE CAPACITOR

(75) Inventor: Kazuo Kawai, Tokyo (JP)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: GENERAL RESEARCH OF ELECTRONICS, INC., Tokyo (JP)

(21) Appl. No.: 11/674,836

(22) Filed: Feb. 14, 2007

(30) Foreign Application Priority Data
Feb. 16, 2006 (JP) 2006-39475

(51) Int. Cl. H01G 4/255

(52) U.S. Cl. 361/272

(57) ABSTRACT

The present invention provides an active capacitor that includes an active all-pass type 90° phase delaying circuit comprising an operational amplifier, a first resistor connected between an inversion input end of the operational amplifier and an input terminal, a second resistor connected between a non-inversion input end of the operational amplifier and the input terminal, a third resistor connected between an output end of the operational amplifier and the non-inversion input end, and a capacitor connected between the non-inversion input end and a ground point; and a fourth resistor having a resistance value sufficiently lower than respective resistance values of the first through third resistors connected between input and output terminals of the active all-pass type 90° phase delaying circuit and an impedance value of the capacitor. Thus, an equivalent capacitor is obtained between the input terminal and the ground point.

### RELATED/PRIORITY APPLICATION

This application claims priority with respect to Japanese Application No. 2006-39475, filed Feb. 16, 2006.

### BACKGROUND OF THE INVENTION

1. Field of the Invention

The present invention relates to an active capacitor, and particularly to an active capacitor capable of obtaining a variable capacitance value between input terminals using one operational amplifier, a plurality of resistors and one reactive element.

2. Description of the Related Art

When the cut-off frequencies of a low-pass filter and a high-pass filter are changed thereat and the pass and stop bands of a bandpass filter and a band rejection or stop filter are changed thereat, it is generally necessary to change or vary the capacitance values of capacitors used in these filters. In such a case, when a relatively high-capacity capacitor of about 1000 pF or more is needed, a plurality of fixed-capacitance value type capacitors each having a necessary capacitance value are prepared in advance and circuit connection states of these capacitors are switched as needed to obtain a desired capacitance value. On the other hand, when a relatively small-capacitance capacitor of about 1000 pF or less is required, a variable capacitance diode is used as the capacitor to change a bias drive voltage supplied thereto, thereby obtaining a desired capacitance value.

Meanwhile, means for preparing the plurality of fixed capacitance value type capacitors each having the necessary capacitance value in advance and switching the circuit connection states of these capacitors as needed thereby to obtain the desired capacitance value must prepare a large number of fixed capacitance capacitors each set to a necessary capacitance value in advance. Increasing the number of the fixed capacitance capacitors at this time causes not only complexity of a switching circuit for performing switching between the circuit connection states of these capacitors correspondingly but also an inability to suddenly obtain the capacitance values of capacitors, which are different from the capacitance values used up to now even though the capacitors are required. Means that uses the variable capacitance diode as the capacitor needs to determine a non-linear characteristic of the variable capacitance diode in advance because the relationship of change between the bias drive voltage supplied to the variable capacitance diode and the junction capacitance value of the variable capacitance diode is not linear. Further, the means needs to obtain a required bias drive voltage from the non-linear characteristic determined upon its use in terms of the voltage and needs a cumbersome operation upon obtaining a desired capacitance value.

### SUMMARY OF THE INVENTION

The present invention has been made in view of such a technical background. It is therefore an object of the present invention to provide an active capacitor capable of remarkably simplifying a circuit configuration by using an active all-pass type 90° phase delaying circuit comprising a signal operational amplifier, a plurality of resistors and a single reactive element and changing a capacitance value of the active capacitor by adjusting a resistance value of one resistor.

In order to attain the above object, there is provided an active capacitor according to the present invention, which includes first constituting means comprising:

input terminals;

an active all-pass type 90° phase delaying circuit comprising an operational amplifier, a first resistor connected between an inversion input end of the operational amplifier and the corresponding input terminal, a second resistor connected between a non-inversion input end of the operational amplifier and the input terminal, a third resistor connected between an output end of the operational amplifier and the inversion input end, and a capacitor connected between the non-inversion input end of the operational amplifier and a ground point; and

a fourth resistor having a resistance value sufficiently lower than respective resistance values of the first through third resistors connected between input and output terminals of the active all-pass type 90° phase delaying circuit and an impedance value of the capacitor,

whereby an equivalent capacitor is obtained between the input terminal and the ground point.

In order to attain the above object, there is provided an active capacitor according to the present invention, which includes second constituting means comprising:

input terminals;

an active all-pass type 90° phase delaying circuit comprising an operational amplifier, a first resistor connected between an inversion input end of the operational amplifier and the corresponding input terminal, an inductor connected between a non-inversion input end of the operational amplifier and the input terminal, a second resistor connected between an output end of the operational amplifier and the inversion input end, and a third resistor connected between the non-inversion input end of the operational amplifier and a ground point; and

a fourth resistor having a resistance value sufficiently lower than respective resistance values of the first through third resistors connected between input and output terminals of the active all-pass type 90° phase delaying circuit and an impedance value of the capacitor,

whereby an equivalent capacitor is obtained between the input terminal and the ground point.

The first constituting means and the second constituting means are respectively obtained based on the following principle of constitution. That is, a capacitor is one wherein the phase of a flowing current leads by 90° the phase of a voltage applied thereto. A circuit that assumes the same phase state as these phase states is configured using an operational amplifier, a capacitor and a resistor or configured using an operational amplifier, an inductor and a resistor. Such a circuit may be set to such a configuration that after the formation of an active all-pass type 90° phase delaying circuit for allowing an input signal to be phase-delayed by 90°, a current that flows from an input terminal to the active all-pass type 90° phase delaying circuit is controlled using a signal outputted from the active all-pass type 90° phase delaying circuit. Thus, an active capacitor can be obtained between input terminals.

According to an active capacitor of the present invention as described above in detail, it is configured using an active all-pass type 90° phase delaying circuit constituted of a single operational amplifier, a plurality of resistors and a single reactive element, and a resistor having a small resistance value, which is connected between an input and output of the active all-pass type 90° phase delaying circuit. Therefore, the active capacitor brings about advantageous effects in that it can not only simplify its circuit configuration remarkably but also obtain an extensively changed capacitance value by adjusting the resistance value of one of the plurality of resistors.

Other features and advantages of the present invention will become apparent upon a reading of the attached specification.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 shows a first embodiment of an active capacitor according to the present invention and is a circuit diagram showing a circuit configuration thereof; and

FIG. 2 shows a second embodiment of an active capacitor according to the present invention and is a circuit diagram showing a circuit configuration thereof.

### DETAILED DESCRIPTION OF THE PREFERRED EMBODIMENTS

Preferred embodiments of the present invention will be described hereinafter with reference to the accompanying drawings.

### First Preferred Embodiment

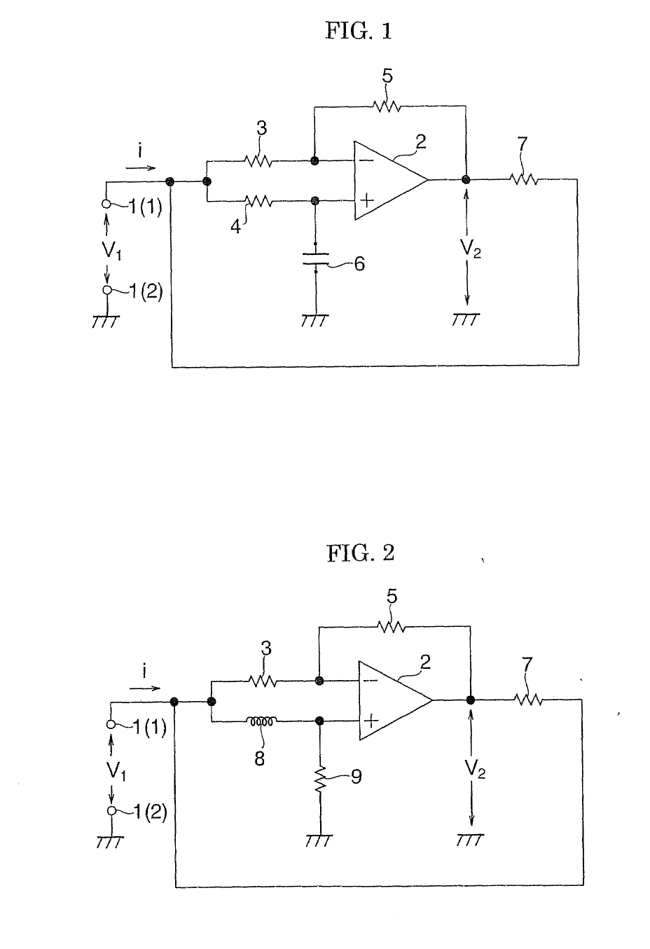

FIG. 1 shows a first embodiment of an active capacitor according to the present invention and is a circuit diagram showing a circuit configuration thereof.

As shown in FIG. 1, the active capacitor according to the first embodiment comprises input terminals 1(1) and 1(2), an operational amplifier 2, a first resistor 3, a second resistor 4, a third resistor 5, a capacitor 6 and a fourth resistor 7. The operational amplifier 2 has an inversion input end (−) connected with the first resistor 3 which is connected between the inversion input end (−) thereof and the input terminal 1(1), a non-inversion input end (+) connected with the second resistor 4 which is connected between the non-inversion input end (+) thereof and the input terminal 1(1), and an output end connected with the third resistor 5 which is connected between the output end thereof and the inversion input end (−). The capacitor 6 is connected between the non-inversion input end (+) of the operational amplifier 2 and a ground point. The fourth resistor 7 is connected between the output end of the operational amplifier 2 and the input terminal 1(1). In this case, a circuit section comprising the operational amplifier 2, the first resistor 3, the second resistor 4, the third resistor 5 and the capacitor 6 constitutes an active all-pass type 90° phase delaying circuit that allows signals lying in all used frequency bands to pass therethrough.

When a resistance value R₁ of the first resistor 3 and a resistance value R₂ of the third resistor 5 are selected equally (R₁=R₂) assuming that under the above configuration, an input drive voltage applied between the input terminals 1(1) and 1(2) is V₁, an output voltage developed at the output of the operational amplifier 2 is V₂, the resistance value of the first resistor 3 is R₁, the resistance value of the second resistor 4 is R₀, the resistance value of the third resistor 5 is R₂, the capacitance value of the capacitor 6 is C₀ and the resistance value of the fourth resistor 7 is r, the following equation (1) is established at the active capacitor according to the above configuration.

That is, a transfer function V₂/V₁ at the active all-pass type 90° phase delaying circuit is expressed as indicated by the following equation (1) if s is assumed to be a Laplace transformer:

$$\frac{{V}_{2}}{{V}_{1}} = \frac{s - \frac{1}{{C}_{0} {R}_{0}}}{s + \frac{1}{{C}_{0} {R}_{0}}} \qquad ( 1 )$$

The active all-pass type 90° phase delaying circuit used herein has all-pass characteristics with respect to all used frequencies as indicated by the equation (1). It performs a phase shift of exactly −90° at a frequency ω=1/C₀R₀.

Assuming that the resistance value r of the fourth resistor 7 is set to a resistance value considerably smaller than the resistance value R₁ of the first resistor 3, the resistance value R₀ of the second resistor 4, the resistance value R₂ of the third resistor 5 and the capacitance value 1/sC₀ of the capacitor 6 in the active capacitor according to the first embodiment, a current i based on the drive voltage V₁ applied between the input terminals 1(1) and 1(2) practically flows through the fourth resistor 7 having the resistance value r. The current i is expressed in the following equation (2):

$$i = \frac{{V}_{1} - {V}_{2}}{r} \qquad ( 2 )$$

If an input impedance V₁/i of the active capacitor according to the first embodiment is determined from these equations (1) and (2), it is then given as expressed in the following equation (3):

$$\frac{{V}_{1}}{i} = \frac{r}{2} + \frac{r}{2 {C}_{0} {R}_{0} s} \qquad ( 3 )$$

Thus, if the active capacitor according to the first embodiment is expressed as an equivalent capacitance C₁ using the resistance value R₀ of the second resistor 4, the capacitance value C₀ of the capacitor 6 and the resistance value r of the fourth resistor 7, it then becomes C₁=2C₀R₀/r. A resistance component at this time results in r/2. Now consider the following as one example of the active capacitor. That is, when the capacitance value C₀ of the capacitor 6 is assumed to be 0.01 μF, the resistance value R₀ of the second resistor 4 is assumed to be 10 kΩ and the resistance value r of the fourth resistor 7 is assumed to be 2Ω respectively, 100 μF can be obtained as the equivalent capacitance C₁. If the capacitance value C₀ of the capacitor 6 is set to 10 pF and the resistance value R₀ of the second resistor 4 is changed from 1 kΩ to 500 kΩ, then the equivalent capacitance C₁ can be continuously changed from 0.01 μF to 5 μF. Thus, the equivalent capacitance C₁ becomes a value proportional to the resistance value R₀ of the second resistor 4.

### Second Preferred Embodiment

Next, FIG. 2 shows a second embodiment of an active capacitor according to the present invention and is a circuit diagram showing a circuit configuration thereof.

As shown in FIG. 2, the active capacitor according to the second embodiment comprises input terminals 1(1) and 1(2), an operational amplifier 2, a first resistor 3, an inductor 8, a third resistor 5 (corresponding to a second resistor as defined in claim 2), a fifth resistor 9 (corresponding to a third resistor as defined in claim 3) and a fourth resistor 7. The operational amplifier 2 has an inversion input end (−) connected with the first resistor 3 which is connected between the inversion input end (−) thereof and the input terminal 1(1), a non-inversion input end (+) connected with the inductor 8 which is connected between the non-inversion input end (+) thereof and the input terminal 1(1), and an output end connected with the third resistor 5 which is connected between the output end of the operational amplifier 2 and the inversion input end (−) thereof. The fifth resistor 9 is connected between the non-inversion input end (+) and a ground point. The fourth resistor 7 is connected between the output end of the operational amplifier 2 and the input terminal 1(1) thereof. Even in this case, a circuit section comprising the operational amplifier 2, the first resistor 3, the inductor 8, the second resistor 5 and the fifth resistor 9 constitutes an active all-pass type 90° phase delaying circuit that allows signals lying in all used frequency bands to pass therethrough.

When a resistance value R₁ of the first resistor 3 and a resistance value R₂ of the third resistor 5 are selected equally (R₁=R₂) assuming that under the above configuration, a drive voltage applied between the input terminals 1(1) and 1(2) is V₁, an output voltage developed at the output end of the operational amplifier 2 is V₂, the resistance value of the first resistor 3 is R₁, the inductance value of the inductor 8 is L₀, the resistance value of the third resistor 5 is R₂, the resistance value of the fifth resistor 9 is R₀, and the resistance value of the fourth resistor 7 is r, the following equation (4) is established at the active capacitor according to the above configuration.

That is, a transfer function V₂/V₁ at the active all-pass type 90° phase delaying circuit is expressed as indicated by the following equation (4) if s is assumed to be a Laplace transformer:

$$\frac{{V}_{2}}{{V}_{1}} = \frac{s - \frac{{R}_{0}}{{L}_{0}}}{s + \frac{{R}_{0}}{{L}_{0}}} \qquad ( 4 )$$

Even in this case, the active all-pass type 90° phase delaying circuit has all-pass characteristics with respect to all used frequencies as indicated by the equation (4). It performs a phase shift of exactly −90° at a frequency ω=R₀/L₀.

Assuming that the resistance value r of the fourth resistor 7 is set to a resistance value considerably smaller than the resistance value R₁ of the first resistor 3, the inductance value sL₀ of the inductor 8, the resistance value R₂ of the third resistor 5, and the resistance value R₀ of the fifth resistor 9 even in the active capacitor according to the second embodiment, a current i based on the drive voltage V₁ applied between the input terminals 1(1) and 1(2) practically flows through the fourth resistor 7 having the resistance value r. The current i is expressed in the previous equation (2).

If an input impedance V₁/i of the active capacitor according to the second embodiment is determined from these equations (4) and (2), it is then given as expressed in the following equation (5):

$$\frac{{V}_{1}}{i} = \frac{r}{2} + s \frac{{L}_{0} r}{2 {R}_{0} s} \qquad ( 5 )$$

Thus, if the active capacitor according to the second embodiment is expressed as an equivalent capacitance C₂ using the resistance value R₀ of the fifth resistor 9, the inductance value L₀ of the inductor 8 and the resistance value r of the fourth resistor 7, then the active capacitor becomes C₂=2R₀/L₀r. In the second embodiment, there is a need to set the inductance value of the inductor 8 to 100,000 H even though the resistance value R₀ of the fifth resistor 9 is set to 10Ω, in order to obtain 100 μF as the equivalent capacitance C₂ assuming that the resistance value r of the four resistor 7 is 2Ω. Therefore, it is advantageous to use the active capacitor according to the first embodiment as compared with the active capacitor according to the second embodiment.

While the preferred forms of the present invention have been described, it is to be understood that modifications will be apparent to those skilled in the art without departing from the spirit of the invention. The scope of the invention is to be determined solely by the following claims.

What is claimed is:

1. An active capacitor comprising:
input terminals;
an active all-pass type 90° phase delaying circuit comprising an operational amplifier, a first resistor connected between an inversion input end of the operational amplifier and the corresponding input terminal, a second resistor connected between a non-inversion input end of the operational amplifier and the input terminal, a third resistor connected between an output end of the operational amplifier and the inversion input end, and a capacitor connected between the non-inversion input end of the operational amplifier and a ground point; and
a fourth resistor having a resistance value sufficiently lower than respective resistance values of the first through third resistors connected between input and output terminals of the active all-pass type 90° phase delaying circuit and an impedance value of the capacitor,
whereby an equivalent capacitance is obtained between the input terminal and the ground point.

2. An active capacitor comprising:
input terminals;
an active all-pass type 90° phase delaying circuit comprising an operational amplifier, a first resistor connected between an inversion input end of the operational amplifier and the corresponding input terminal, an inductor connected between a non-inversion input end of the operational amplifier and the input terminal, a second resistor connected between an output end of the operational amplifier and the inversion input end, and a third resistor connected between the non-inversion input end of the operational amplifier and a ground point; and
a fourth resistor having a resistance value sufficiently lower than respective resistance values of the first through third resistors connected between input and output terminals of the active all-pass type 90° phase delaying circuit and an impedance value of the inductor,
whereby an equivalent capacitor is obtained between the input terminal and the ground point.
